(19) United States
(12) Patent Application Publication
(10) Pub. No.: US 2025/0358791 A1
(43) Pub. Date: Nov. 20, 2025

(54) UNLICENSED SPECTRUM TRANSMISSION

(71) Applicant: Nokia Technologies Oy, Espoo (FI)

(72) Inventors: Lorenzo GALATI GIORDANO, Stuttgart (DE); Gianluca Attilio FONTANESI, Stuttgart (DE); Francisco WILHELMI, Stuttgart (DE)

(21) Appl. No.: 19/201,694

(22) Filed: May 7, 2025

(30) Foreign Application Priority Data
May 15, 2024 (GB) 2406889.2

(51) Int. Cl. H04W 72/02; H04W 72/0457; H04W 72/51; H04W 72/543

(52) U.S. Cl. CPC H04W 72/02; H04W 72/0457; H04W 72/51; H04W 72/543

(57) ABSTRACT

There is herein disclosed a method including receiving a base band stream and converting the base band stream into a set of data samples. The set of data samples includes a first set of data samples and a second set of data samples. The method includes selecting a sequence of available channels from a plurality of channels in an unlicensed spectrum. A bandwidth of each channel of the sequence of available channels is according to a bandwidth configuration defined by a cellular protocol and the selected sequence of available channels comprises a first channel and a second channel. The method includes transmitting, to a receiver, the selected sequence of available channels and transmitting, to the receiver, during a first transmission period, the first set of data samples via the first channel. The method further includes transmitting, to the receiver, prior to transmission of the second set of data samples via the second channel, a preamble according to a Wi-Fi protocol and transmitting, to the receiver, after expiration of the first transmission period, during a second transmission period, the second set of data samples via the second channel.

### FIELD

Various example embodiments relate to communications within the unlicensed spectrum.

### BACKGROUND

The unlicensed spectrum provides an opportunity to increase the bandwidth available for signals to be transmitted. However, as this bandwidth is shared with other devices scanning may be required prior to transmission to reduce interference. Furthermore, there may be rules regarding how often a device can scan to allow the spectrum to be fairly shared and these issues can lead to increased latency.

The unlicensed band is divided into sub-bands or channels each covering a certain frequency band. Scanning procedures such as listen before talk (LBT), which involves, the sensing of a channel to determine whether it is available, may be used prior to transmitting a signal. Where it is determined that the channel is available then it may be acquired by the node for a predetermined occupancy time which may be termed a channel occupancy time COT. During this time signals may be sent and other nodes are deterred from using the channel.

Increasingly devices are able to transmit and receive on more than one channel and this may be used to increase throughput and/or increase reliability. A potential problem may arise with discontinuities in communication when the occupancy period in one channel expires and a further channel is yet to be acquired.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is described an apparatus comprising: receiving a base band stream, means for converting the base band stream into a set of data samples, the set of data samples comprises a first set of data samples and a second set of data samples, means for selecting a sequence of available channels from a plurality of channels in an unlicensed spectrum, a bandwidth of each channel of the sequence of available channels is according to a bandwidth configuration defined by a cellular protocol and the selected sequence of available channels comprises a first channel and a second channel, means for transmitting, to a receiver, the selected sequence of available channels, means for transmitting, to the receiver, during a first transmission period, the first set of data samples via the first channel, means for transmitting, to the receiver, prior to transmission of the second set of data samples via the second channel, a preamble according to a Wi-Fi protocol, and means for transmitting, to the receiver, after expiration of the first transmission period, during a second transmission period, the second set of data samples via the second channel.

In some embodiments, the means for transmitting, to a receiver, the selected sequence of available channels may be configured to use multi-link operation.

In some embodiments, the apparatus may be configured to use at least one channel of the selected sequence of available channels during a preconfigured transmission period, and wherein a first preconfigured transmission period for the first channel is the first transmission period and a second preconfigured transmission period for the second channel is the second transmission period.

In some embodiments, the preamble may be according to a Wi-Fi protocol and is configured to enable synchronization between the apparatus and the receiver.

In some embodiments at least one of the first set of data samples or the second set of data samples may be transmitted to the receiver via cellular protocol.

In some embodiments, the apparatus further comprises: means for negotiating with the receiver to determine the selection of the sequence of available channels from the plurality of channels. The negotiating may be based on at least one of the following: a radio frequency capability of at least one of the plurality of channels, a radio frequency capability of a transceiver associated with at least one of the plurality of channels, a resource availability of at least one of the plurality of channels, or a propagation characteristic of at least one of the plurality of channels.

In some embodiments, the means for selecting the sequence of available channels may include: means for scanning at least one channel of the plurality of channels, means for acquiring an available scanned channel for an occupancy time, and means for acquiring the available scanned channel for the occupancy time.

In some embodiments, selecting the sequence of available channel further includes upon determining that the occupancy time has expired, acquiring a second available scanned channel for a second occupancy time.

In some embodiments, the apparatus include means for receiving, from the receiver, at least one quality of service (QoS) requirement, and means for selecting a sequence of available channels from the plurality of channels, based on the QoS requirement.

In some embodiments, the apparatus comprises a continuous transmission and reception wrapper transmission unit -CTR-WR TX-, the CTR-WR TX configured to provide continuous transmission to the receiver, using a plurality of unlicensed channels and the preamble according to a Wi-Fi protocol.

According to a second aspect, there is described an apparatus comprising: means for receiving, from a transceiver, a sequence of available channels of a plurality of channels in an unlicensed spectrum, a bandwidth of each channel of the sequence of available channels is according to a bandwidth configuration defined by a cellular protocol and the selected sequence of available channels comprises a first channel and a second channel, means for receiving, from the transceiver, during a first transmission period, a first set of data samples via the first channel, means for receiving, from the transceiver, prior to receiving of the second set of data samples via the second channel, a preamble according to a Wi-Fi protocol; and means for receiving, from the transceiver, after expiration of the first transmission period, during a second transmission period, the second set of data samples via the second channel.

In some embodiments, the means for receiving, from the transceiver, the selected sequence of available channels may be configured to use multi-link operation.

In some embodiments, the apparatus may be configured to use at least one channel of the selected sequence of available channels during a preconfigured transmission period, a first preconfigured transmission period for the first channel is the first transmission period and a second preconfigured transmission period for the second channel is the second transmission period.

In some embodiments, the preamble may be according to a Wi-Fi protocol and is configured to enable synchronization between the apparatus and the transceiver.

In some embodiments, at least one of the first set of data samples or the second set of data samples may be received from the transceiver via cellular protocol.

In some embodiments, the apparatus may include means for negotiating with the transceiver to determine the selection of the sequence of available channels from the plurality of channels. The negotiating is based on at least one of the following: a radio frequency capability of at least one of the plurality of channels, a radio frequency capability of a transceiver associated with at least one of the plurality of channels, a resource availability of at least one of the plurality of channels, or a propagation characteristic of at least one of the plurality of channels.

In some embodiments, the apparatus may include means for transmitting, to the transceiver, at least one quality of service (QoS) requirement.

In some embodiments, the apparatus may include means for monitoring the receiving of the first set of data samples and the second set of data samples to determine whether continuous transmission is achieved.

In some embodiments, the apparatus may be a continuous transmission and reception wrapper receiver unit -CTR-WR RX-, the CTR-WR RX configured to receive continuous transmission from the transceiver using a plurality of unlicensed channels and the preamble according to a Wi-Fi protocol.

According to a third aspect, there is described a method comprising: receiving a base band stream, converting the base band stream into a set of data samples, the set of data samples comprises a first set of data samples and a second set of data samples, selecting a sequence of available channels from a plurality of channels in an unlicensed spectrum, a bandwidth of each channel of the sequence of available channels is according to a bandwidth configuration defined by a cellular protocol and the selected sequence of available channels comprises a first channel and a second channel, transmitting, to a receiver, the selected sequence of available channels, transmitting, to the receiver, during a first transmission period, the first set of data samples via the first channel, transmitting, to the receiver, prior to transmission of the second set of data samples via the second channel, a preamble according to a Wi-Fi protocol, and transmitting, to the receiver, after expiration of the first transmission period, during a second transmission period, the second set of data samples via the second channel.

According to a fourth aspect, there is described a method comprising: receiving, from a transceiver, a sequence of available channels of a plurality of channels in an unlicensed spectrum, a bandwidth of each channel of the sequence of available channels is according to a bandwidth configuration defined by a cellular protocol and the selected sequence of available channels comprises a first channel and a second channel, receiving, from the transceiver, during a first transmission period, a first set of data samples via the first channel, receiving, from the transceiver, prior to receiving of the second set of data samples via the second channel, a preamble according to a Wi-Fi protocol; and receiving, from the transceiver, after expiration of the first transmission period, during a second transmission period, the second set of data samples via the second channel.

According to a fifth aspect, there is provided a computer program product comprising a set of instructions which, when executed on an apparatus, is configured to cause the apparatus to carry out the method of any preceding method definition.

According to a sixth aspect, there is provided a non-transitory computer readable medium comprising program instructions stored thereon for performing any preceding method according to the definition of the third or fourth aspect.

### BRIEF DESCRIPTION OF THE DRAWINGS

Example embodiments will now be described by way of non-limiting example, with reference to the accompanying drawings, in which:

FIG. 1 shows transmission in the licensed spectrum;

FIG. 2 shows problems associated with operating cellular protocols in the unlicensed spectrum;

FIG. 3 shows illustrates a multi-link communication in the unlicensed spectrum according to an embodiment;

FIG. 4a shows a continuous transmission and reception wrapper transmission unit and FIG. 4b shows a continuous transmission and reception wrapper reception unit.

FIG. 5 shows a first flow diagram illustrating steps in a method of performing multi-link communication according to an embodiment;

FIG. 6 shows a second flow diagram illustrating steps in a method of performing multi-link communication according to an embodiment;

FIG. 7 shows an example apparatus according to an embodiment.

### DETAILED DESCRIPTION

Before discussing the example embodiments in any more detail, first an overview will be provided.

Peak data rates for WLAN/Wi-Fi have increased by roughly four orders of magnitudes in the two and a half decades since its introduction. However, any technology operating in unlicensed bands is subject to uncontrolled interference which affect highly reliable operation. A lack of reliability is increasingly unacceptable and there are ultra-reliable low-latency communication (URLLC) requirements being introduced to provide a higher determinism in Wi-Fi communications. This is not an easy task, since medium access control (MAC) was originally designed upon carrier sense multiple access with collision avoidance (CSMA/CA) to cope with uncoordinated usage in the licensed-exempt spectrum, rather than prioritize determinism.

Mobile operators have historically turned their attention to unlicensed spectrum bands to improve the capacity with abundant bands and to offload traffic from precious licensed frequencies. Any device that operates in the unlicensed spectrum has to be designed in accordance with the regulatory requirements of the corresponding bands. The regulation in place in the unlicensed spectrum <7 GHz for wireless communication systems typically mandates the use of Listen-before-Talk (LBT) techniques. LBT is a channel access mechanism by which a device senses the wireless channel and, through the application of a predefined threshold decides whether it can proceed with the transmission or if it needs to back-off (i.e., wait until the channel becomes free).

Current unlicensed portions of the spectrum are extremely attractive for future cellular networks due to their good propagation characteristic, large global availability, and abundance. There is a particular focus on the opportunity to make the 6 GHz band, currently in use by unlicensed satellite services and Wi-Fi 6E/Wi-Fi 7 devices, partially available for cellular use.

Like its predecessors, 6G is set to explore potential use of the unlicensed frequencies in its quest for enabling large channel bands, like the one below 7 GHz. However, in these unlicensed bands, 6G will always face the competition of the Wi-Fi technology, with its almost 20 billion devices deployed around the World. So, to make the use of these unlicensed bands a successful commercial case, 6G will need to consider and solve the shortcomings emerged in the past attempts to adapt the cellular protocols.

First of all, cellular protocols are meant to operate in reserved spectrum resources by means of transmitting specific continuous frames and subframes following regular and predefined patterns. Instead, the regulation in place to guarantee a fair usage of the unlicensed spectrum (<7GHz) generally entails the implementation of channel contention mechanisms that do not guarantee the possibility to transmit continuously, thus breaking the periodicity of certain control information and reference signals and requiring for significant protocol modifications. Secondly, the approach followed by 5G NR-Unlicensed went in the direction of introducing modifications to certain control channels and operations of the “licensed” version of the protocol in order to cope with the above-mentioned uncertainty of transmission. These patches required a design of a different chipset, thus limiting the diffusion and adoption of 5G-NRU.

The IEEE 802.11be task group, which defines the set of features that are implemented in currently available Wi-Fi 7 devices, has introduced the capability of performing multi-link operations (MLO). MLO allows devices to dynamically operate on several channels/bands simultaneously through a single association. With this multi-link feature, each packet may be delivered through any of the channels/links leading to increased peak throughput and decreased channel access delay, as devices can simultaneously contend on multiple channels/links and select the first one available for data transmission. The MLO framework introduces an additional flexibility in the way the unlicensed spectrum is accessed and opens for future innovations.

Cellular technology in the unlicensed spectrum has been attracting lot of interest for industrial use cases, due to large spectrum availability and ease of access. Several modifications in the 3rd Generation Partnership Project (3GPP) standard specifications, which started with 4G LTE Licensed-Assisted Access (LAA), MulteFire, and recently 5G New Radio-based access to unlicensed spectrum (NR-U). LAA allows the usage of unlicensed spectrum alongside LTE licensed spectrum. MulteFire has been created to allow a standalone operation of LTE-like technology in the unlicensed band, without the need for paired licensed spectrum. The primary objective of NR-U is to extend the applicability of NR to the unlicensed spectrum as a general-purpose technology that works across different bands and uses a design that allows fair coexistence across different radio access technologies (RATs). However, these attempts for extending cellular communications operations in the unlicensed bands resulted in limited application due to the need of implementing new protocol extensions and usage of dedicated chipsets.

The disclosure herein proposes a unique approach for maintaining continuity of transmission for cellular communication protocols, like 6G, when using the unlicensed spectrum. The disclosed approach does not require protocol modifications or modified baseband chipset, and it is totally transparent to the operating frequency. As a result, the proposed approach might enable a smooth deployment and coexistence of cellular technologies in the 6 GHZ, currently entirely in use in the US by Wi-Fi and other satellite services.

The disclosure herein aims to enable the utilization of cellular communication protocols in the unlicensed spectrum, where channel contentions regulate the spectrum access, without the need for neither any protocol nor any baseband chipset modifications. This allows for a paradigm shift with respect to past approaches and could have potentials for significant commercial opportunities and increased diffusion and performance of cellular communications, e.g. utilization of the full 6 GHz band in the US with 1.2 GHz of spectrum (currently assigned for Wi-Fi and other satellite service).

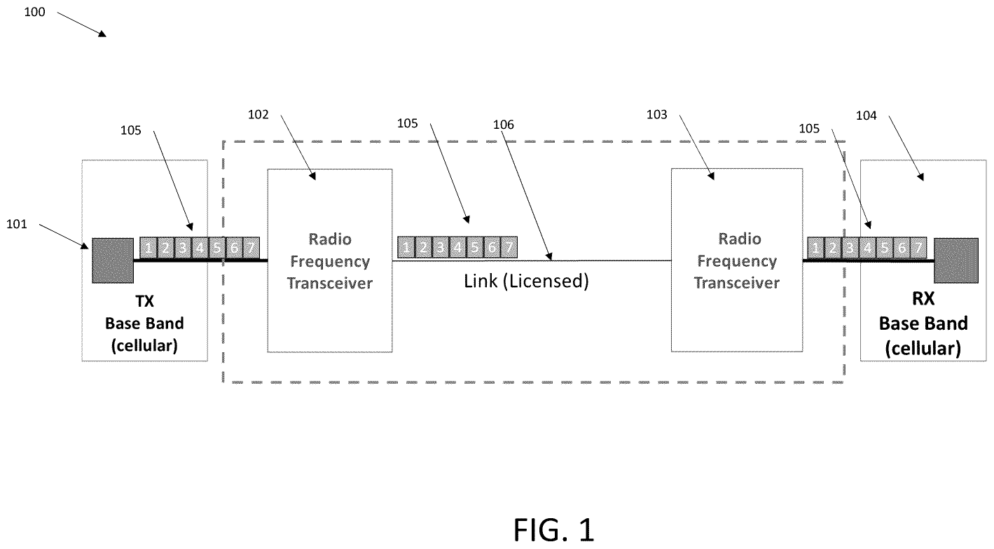

By way of context, FIG. 1 illustrates a licensed channel communication apparatus 100. In FIG. 1 base band stream 101 (received at a base band unit) is input to a first radio frequency transceiver 102 for transmission to a second radio frequency transceiver 103 from which the base band stream is output 104. The base band stream 101 refers to radio frequency samples which comprise data that is transmitted over the air. The base band stream 101 is transmitted via a licensed link 106 comprising a series of licensed channels 105. The apparatus 100 may select the preferred licensed channel from the series of licensed channels 105 to transmit the base band stream 101.

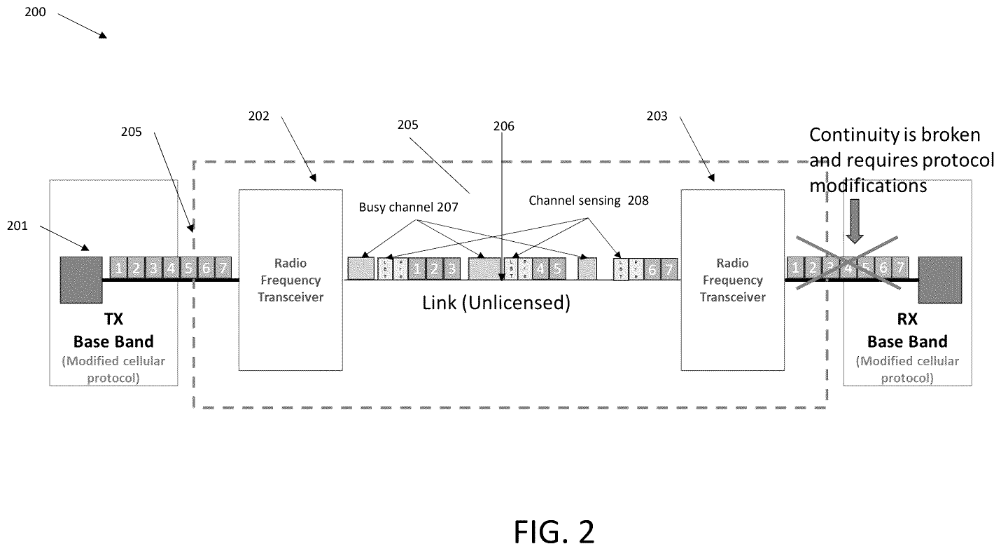

FIG. 2 illustrates an unlicensed spectrum communication apparatus 200. In FIG. 2 base band stream 201 is similarly input to a first radio frequency transceiver 202 for transmission to a second radio frequency transceiver 203. A series of unlicensed channels 205 are present for transmission of the base band stream 201 via an unlicensed link 206. The device performs sensing on the unlicensed link 206 and the output of the sensing may include identifying busy channels 207 and free channels for which continued channel sensing 208 can be conducted to determine availability. The transmission in the unlicensed spectrum 200 requires channel access contentions. FIG. 2 indicates that continuity may be broken which results in a disruption of the continuity of the transmission (i.e. there may be increased downtime and latency in communication). This may be caused by busy channels 207 and a wait time required to determine an available free channel. Cellular protocols are designed with the intrinsic assumption that the frequency resources are always available, for example, in the traditional licensed spectrum as shown in FIG. 1 channels reserved through the payment of a license. This may imply that control channels and reference signals follow a certain pattern and position in the time and frequency domain (frame structure). So, in order to have cellular protocols operating in the unlicensed spectrum, specific changes have to be made in order to cope with the inherent discontinuity of the unlicensed spectrum. The disclosure herein aims to solve this problem and avoids the need of modifying existing and upcoming cellular protocols.

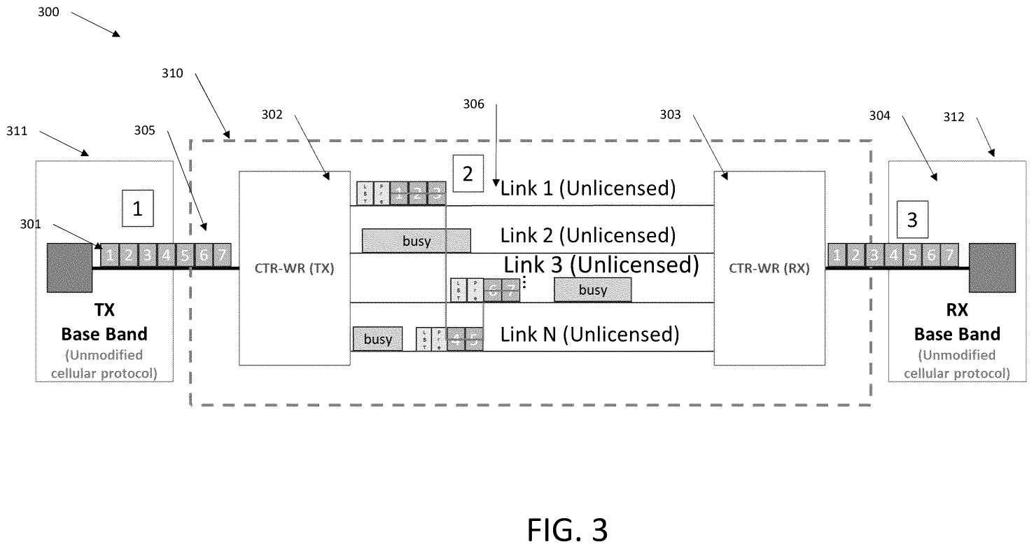

To solve this problem, a continuous transmission and reception wrapper (CTR-WR) is proposed to enable cellular protocols to seamlessly operate in the unlicensed spectrum. As indicated in FIG. 3, the CTR-WR aims at transforming a multitude of links operating in the unlicensed spectrum to behave in a similar fashion to a licensed spectrum link, thus permitting continuity of the transmission and reducing latency.

FIG. 3 illustrates a proposed unlicensed spectrum communication apparatus 300 whereby communication of base band stream can be provided in the unlicensed spectrum. In FIG. 3 base band stream 301 is input to a CTR-WR transmission (TX) unit 302 for transmission to a CTR-WR receiver (RX) unit 303. The transmission of the base band stream occurs by converting the based band stream into a set of data samples and selecting a sequence of available channels from a plurality of channels in an unlicensed spectrum. The apparatus 300 may select the sequence of available channels based on known information about resource availability in each channel. As such, as shown by way of demonstration in FIG. 3, communication in the unlicensed spectrum is firstly achieved on Link 1 on channels 1, 2 and 3, the communication is secondly achieved on Link N on channels 4 and 5, a finally the communication is achieved on Link 3 on channels 6 and 7. Thereby, continuous transmission is achieved in the unlicensed spectrum via the selected the sequence of available channels. When an old link is no longer available and a new link is unavailable the transmission is switched to a new available link.

The dotted line 310 shown in FIG. 3 represents the CTR-WR. This CTR-WR is formed by light software and hardware components which could potentially be integrated in future 6G base stations, and/or connected to the base band units of existing 4G/5G base stations, retroactively, and/or integrated in new handsets, benefitting 6G protocols but also retroactively 4G/5G. The CTR-WR implements the required basic channel sensing capabilities (based on the carrier sense multiple access scheme implemented by Wi-Fi), together with a simplified version of the Wi-Fi multi-link framework. The functionalities of the CTR-WR ensures the readiness for transmission in the unlicensed spectrum by ensuring the baseband samples generated by the cellular protocol will always find an available link/channel where to be transmit without any discontinuity and without the need of being buffered. In this way additional delays can be avoided. The proposed CTR-WR framework is transparent to the mobile operators that will not have to apply any patch/update to their baseband software or chipset update, and instead simply consider the use of a different remote radio head implementing the CTR-WR functionalities. Moreover, the CTR-WR will allow cellular communications to smoothly coexist with Wi-Fi in its operating unlicensed bands, opening the path for a significantly increased spectrum range possibility for cellular communications.

The apparatus 300 receives a base band stream 301 at a base band unit 311, 312. The base band unit may be according to versions of base band units as adopted by the protocol operating in licensed spectrum, i.e. unmodified chipset (2G/3G/4G/5G/6G). The output of these base band unit is transferred to the next functional block (i.e. the CTR-WR TX). This transfer may be through existing CPRI optical connections or integrated in the base station/handset hardware. The CTR-WR, as later described, is in charge of the actual over the air transmission.

A TX base band unit 311 and RX base band unit 312 are shown in FIG. 3. The TX base band unit 311 and RX base band unit 312 represent the 6G baseband processing blocks or may also represent baseband processing blocks for other existing cellular protocols like 4G and 5G. The TX base band unit 311 is responsible for converting a base band stream into a set of data samples, to be transmitted to the CTR-WR TX 302 (as shown in FIG. 3), with no knowledge about the transmitting link. The RX base band unit 312 is responsible for receiving the base band stream comprising the set of data samples from the CTR-WR RX 303 (as shown in FIG. 3). The RX base band unit 312 is agnostic about the transmission link adopted, and ready to process the received data samples (for example demodulating or decoding) with the unmodified corresponding signal processing blocks. The main processing blocks required for CTR-WR transmission thus remain unchanged.

The following considerations apply to the configuration of the base band units 311, 312 since the physical transmission happens over different carrier links:
Random access: as far as random-access sequences are transmitted in links operating in frequencies not too separated, the correlations performed with PRACH sequences required for computing timing advance are not significantly affected. For example, the apparatus 300 may counteract this effect by opportunistically assigning “convenient” links for the transmission of the PRACH sequences.
Carrier Frequency synchronization: over-the-air synchronization is guaranteed by the CTR-WR TX 302 and CTR-WR RX 303 which will be described further below. Any remaining synchronization error in the baseband received samples may be compensated for in a seamless manner using traditional carrier frequency offset compensation techniques adopted in the cellular protocols' receiver blocks.
Channel coherence time: since propagation characteristics and reflections may be different in the different links, as links may also operate in a quite sparse set of frequencies (e.g. from 2.4 GHz to 6 GHz), channel coherence time may vary. However, radio frequency samples transmitted over each link are equipped with additional cyclic prefixes added by the CTR-WR. This ensures to absorb the channel delays at each link, individually.
Frame, subframe continuity: even in presence of small gaps in the continuity enforced by the CTR-WR, known existing baseband error correction mechanisms and retransmissions provide methods for easily tolerating these small caps in continuity.

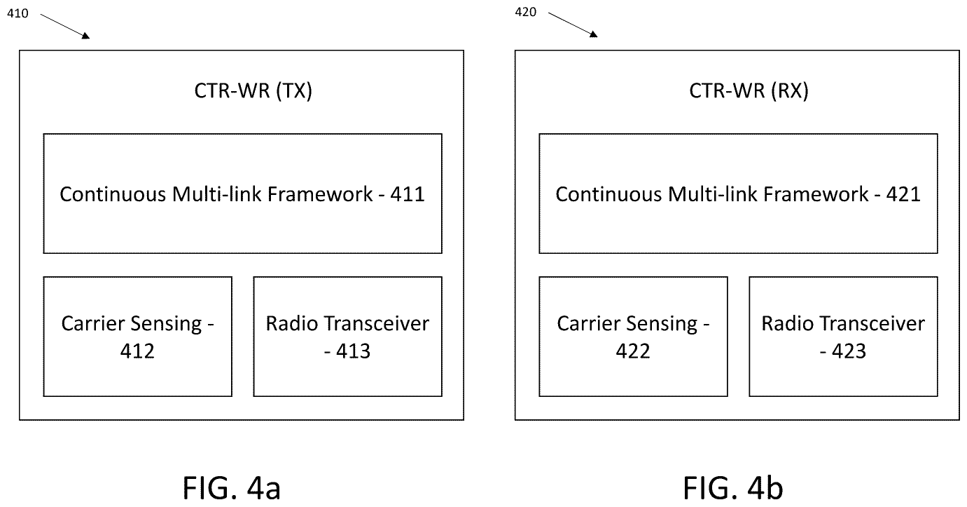

FIG. 4a shows a proposed CTR-WR TX unit 410 which may be equivalent to the CTR-WR TX unit 302 shown in FIG. 3. The CTR-WX TX unit 410 comprises a continuous multi-link framework 411, carrier sensing equipment 412 and a radio transceiver 413. The CTR-WR TX unit 410 may comprise a functional block constituted by software and hardware components in charge of receiving the base band streams and distributing them over the unlicensed spectral resources. The role of the CTR-WR TX unit 410 is to dynamically redirect the base band stream towards the appropriate link based on the decisions taken by the continuous multi-link framework 411. No buffering is required for the base band samples.

The continuous multi-link framework 411 provides the establishment of a multi-link framework between the CTR-WR TX unit 410 and a CTR-WR RX unit 420 by implementing basic principles and control messages of Wi-Fi 7 protocol for association and link setup. The CTR-WR TX unit 410 uses radio transceiver 413 to operate in different channels that can be dynamically configured and used following different mode of operations. The continuous multi-link framework 411 also provides activation of a continuous transmission mode of operation, as discussed in relation to FIG. 3, that enables the possibility to have a transmission opportunity always available at any point in time.

The carrier sensing equipment 412 is provided to perform carrier sensing over a multitude of N links as shown in FIG. 3. The CTR-WR TX unit 410 receives base band samples and forwards them towards the radio transceiver 413 that is associated with the link selected for transmission by the continuous multi-link framework 411.

FIG. 4b shows a proposed CTR-WR RX unit 420 which may be equivalent to the CTR-WR RX unit 303 shown in FIG. 3. The CTR-WX RX unit 420 may be constructed in the same manner as the CTR-WR TX 410 and as such may similarly comprise a continuous multi-link framework 421, carrier sensing equipment 422 and a radio transceiver 423. The radio transceiver 423 may also herein be referred to as a receiver, however, bidirectional connection is possible. The CTR-WR RX unit 420 may also comprise a functional block constituted by software and hardware components in charge of receiving the base band streams and distributing them over the unlicensed spectral resources. The role of the CTR-WR RX unit 420 is to receive the base band stream from the appropriate link based on the decisions taken by the continuous multi-link framework 421. The CTR-WR TX unit 410 and CTR-WR RX unit 420 work together to ensure that the continuous transmission can be provided in the unlicensed spectrum via a sequence of available channels. As such, the continuous multi-link framework 411 of the CTR-WR TX unit 410 and the continuous multi-link framework 421 of the CTR-WR RX 420 may be the same framework or may be otherwise connected to each other to ensure that continuous transmission is provided. The continuous multi-link framework 421 provides the establishment of a multi-link framework between the CTR-WR TX unit 410 and a CTR-WR RX unit 420 by implementing basic principles and control messages of Wi-Fi 7 protocol for association and link setup. The CTR-WR RX unit 420 uses radio receiver 423 to operate in different channels that can be dynamically configured and used following different mode of operations. The continuous multi-link framework 421 also provides activation of a continuous transmission mode of operation, as discussed in relation to FIG. 3, that enables the possibility to have a transmission opportunity always available at any point in time.

The carrier sensing equipment 422 is provided to perform carrier sensing over a multitude of N links as shown in FIG. 3. The CTR-WR RX unit 420 receives base band samples at the radio receiver 423 that is associated with the link selected for transmission by the continuously multi-link framework 421. The CTR-WR RX unit 420 receives the radio frequency samples over the link that was appropriately selected and signalled from the continuous multi-link framework 421 and passes the radio frequency samples, which are converted back into base band samples to the base band receiver of the cellular protocol, for example, through existing CPRI optical connections or integrated in the base station/handset hardware.

As such the CTR-WR TX unit 410 and CTR-WR RX unit 420 agree to activate a continuous transmission mode to proactively sense the unlicensed spectrum and ensure that at least one of the available links and/or channels is always ready for transmission. The synchronization between the CTR-WR TX unit 410 and CTR-WR RX unit 420 is performed reusing signalling and controlling messages exchanged during the multi-link framework 411 and 421 establishment. The end-to-end synchronization between the CTR-WR TX unit 410 and CTR-WR RX unit 420 of the cellular protocol is performed using existing baseband processing techniques and procedures.

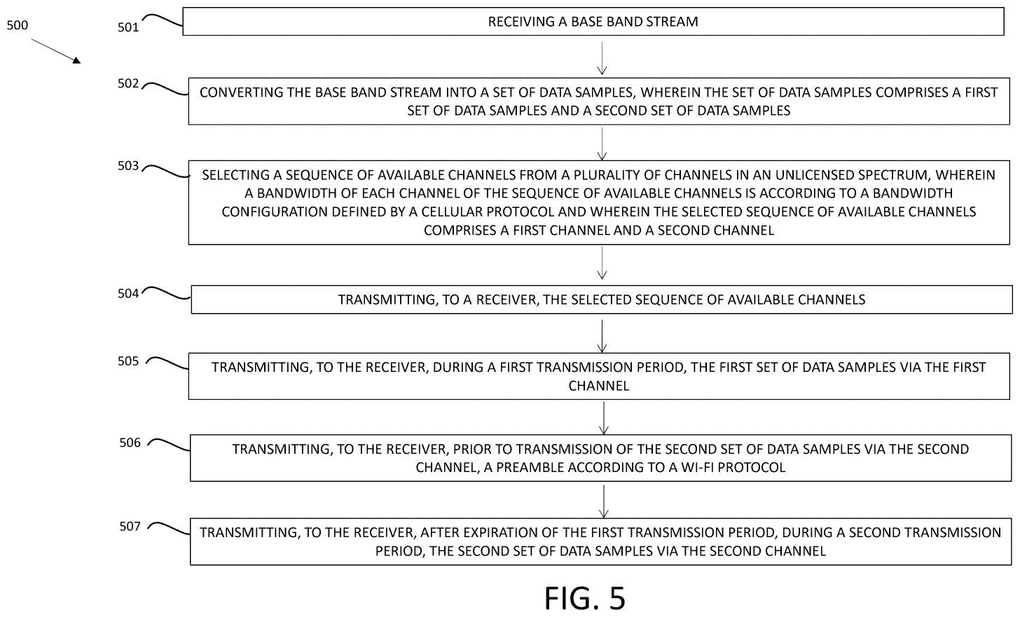

FIG. 5 shows, by way of example, a flowchart of a method 500 according to example embodiments. Each element of the flowchart may comprise one or more operations. The operations may be performed in hardware, software, firmware or a combination thereof. For example, the operations may be performed, individually or collectively, by a means, wherein the means may comprise at least one processor; and at least one memory storing instructions that, when executed by the at least one processor, cause the performance of the operations. The method 500 may be carried out by a CTR-WR TX, such as the CTR-WR TX 302 of FIG. 3 or the CTR-WR TX unit 410 of FIG. 4a.

The method 500 comprises a first operation 501 of receiving, by an apparatus, a base band stream. The base band streams are generated via cellular protocol. The base band stream may be received at a base band unit 311 as shown in FIG. 3 through well-defined cabled interconnection (e.g. Common Radio Public Interface—CPRI), or any other proprietary interfaces or integrated system on chip design. The proposed solution does not require storing the samples in dedicated buffers before they can be transmitted over the unlicensed spectrum since uninterrupted continuous transmission is provided in this method 500. Furthermore, acquiring synchronization from the stream of base band samples (e.g. CPRI protocol) naturally embeds this capability.

The method 500 comprises a second operation 502 of converting the base band stream into a set of data samples. The data samples refer to the radio frequency samples that are transmitted over the air. The baseband samples are converted into the equivalent RF waveform adopted for the cellular communication. The bandwidth of this waveform is fixed and corresponds to the bandwidth of the unlicensed link to be used according to the configuration of the cellular protocol. For example, if the cellular protocol requires 40 MHz band, this corresponds to the scanning/sensing of 40 MHz available channels, thus influencing the selection of the channels themselves.

The set of data samples comprises a first set of data samples and a second set of data samples. The first set of data samples and second set of data samples may each comprise distinct information to be transmitted over the air.

The method 500 comprises a third operation 503 of selecting a sequence of available channels from a plurality of channels in an unlicensed spectrum. The selected sequence of available channels comprises a first channel and a second channel. The third operation 503 may comprise establishing and agreeing on the sequence of available channels over which CTR-WR TX unit 410 and CTR-WR RX unit 420 can possibly communicate. The selection of the sequence of available channels may be performed continuously, thereby meaning that the acquisition of the second channel is performed before the end of the transmission of the first data samples in the first channel.

A bandwidth of each channel of the sequence of available channels is defined according to a bandwidth configuration defined by a cellular protocol. The bandwidth of each link is equal and fixed according to the bandwidth configuration defined by the cellular protocol (e.g. 20 MHz, 40 MHz).

The third operation 503 may further comprise negotiating with the receiver to determine the selection of the sequence of available channels from the plurality of channels. The negotiating is based on at least one of the following: a radio frequency capability of at least one of the plurality of channels (for example, a band width capability of at least one of the plurality of channels), a radio frequency capability of a transceiver associated with at least one of the plurality of channels, a resource availability of at least one of the plurality of channels, or a propagation characteristic of at least one of the plurality of channels.

The third operation 503 may further comprise scanning at least one channel of the plurality of channels, acquiring an available scanned channel for an occupancy time; and acquiring the available scanned channel for the occupancy time. As such the occupancy time may be equivalent to a transmission period that the scanned channel is available for. Furthermore, upon determining that the occupancy time has expired, a second available scanned channel may be acquired for a second occupancy time. The acquisition procedure of the second channel may start before the expiration of the occupancy time on the first channel. The scanning of the channel is performed before the actual transmission of the data samples in order to assess it is free.

The method 500 comprises a fourth operation 504 of transmitting, to a receiver, the selected sequence of available channels. There may be more than one available channel for the apparatus to select, however, an appropriate decision will be made for the best available sequence of available channels based on known resource information. Transmission of the selected sequence of available channels may comprise using multi-link operation via Wi-Fi protocol.

The method 500 comprises a fifth operation 505 of transmitting, to the receiver, during a first transmission period, the first set of data samples via the first channel. The first transmission period may be for a defined time instance that it is known that the first channel is available.

The method 500 comprises a sixth operation 506 of transmitting, to the receiver, prior to transmission of the second set of data samples via the second channel, a preamble according to a Wi-Fi protocol. The preamble is according to a Wi-Fi protocol and is configured to enable synchronization between the apparatus and the receiver. The purpose of the preamble according to Wi-Fi protocol is to allow for addressing a specific receiver and to enable over-the-air synchronization at between the CTR-WR TX unit 410 and CTR-WR RX unit 420 for the correct reception of the successive cellular RF samples. This allows for reusing main components of Wi-Fi communication framework, except for the data transmission that follows the cellular frame structure and waveform. The Wi-Fi waveform is based on Orthogonal Frequency-Division Multiple Access (OFDMA), similarly to cellular waveform, however with different numerology and frame structure. In some embodiments, the preamble may be transmitted prior to transmission of the first set of data samples and prior to the first transmission period In some embodiments, the preamble may be transmitted prior to the end of the first transmission period.

The method 500 comprises a seventh operation 507 of transmitting, to the receiver, after expiration of the first transmission period, during a second transmission period, the second set of data samples via the second channel. The second transmission period may be continuous to the first transmission period such that continuous transmission of the data samples is provided. The apparatus may be reconfigured between the transmission of the first set of data samples in the first transmission period and the transmission of the second set of data samples in the second transmission period. This reconfiguration comprises switching the transmission of data samples from the first channel to the second channel (as shown in FIG. 3). This switching between the first channel and second channel introduces negligible delay. Indeed, any delay which may have been introduced can be absorbed by existing timing advance end-to-end protocols.

Subsequently, an optional operation may be provided of transmitting, to the receiver, prior to transmission of a third set of data samples via a third channel (or back to the first or second channel), a new preamble according to a Wi-Fi protocol. As such the method may then comprise transmitting, to the receiver, after expiration of the second transmission period, during a third transmission period, a third set of data samples via the third channel.

Transmission of the first set of data samples and the second set of data samples to the receiver may be via cellular protocol. Whilst elements of Wi-Fi protocol are used to establish links and send the preamble, the transmission of the first set of data samples and second set of data samples are themselves transmitted as cellular data.

The method 500 may comprise using a set of preconfigured transmission period for the series of available channels. As such the duration of the transmission period may be known and have been decided in advance by the multi-link framework. The selected sequence of available channels may therefore be used during a preconfigured transmission period. For example, a first preconfigured transmission period for the first channel is the first transmission period and a second preconfigured transmission period for the second channel is the second transmission period.

The method 500 may further comprise receiving, from the receiver, at least one quality of service (QoS) requirement, and selecting a sequence of available channels from the plurality of channels, based on the QoS requirement.

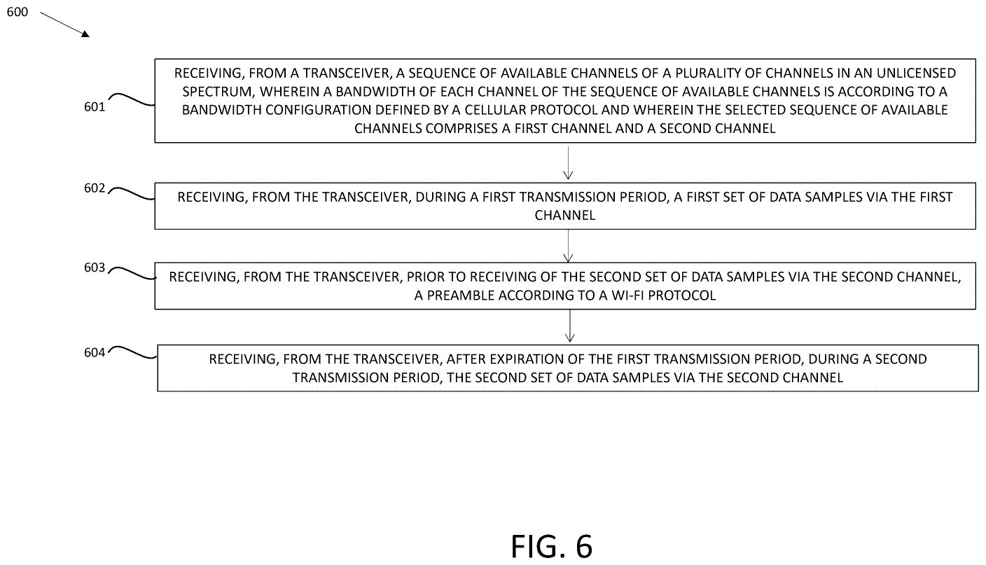

FIG. 6 shows, by way of example, a flowchart of a method 600 according to example embodiments. Each element of the flowchart may comprise one or more operations. The operations may be performed in hardware, software, firmware or a combination thereof. For example, the operations may be performed, individually or collectively, by a means, wherein the means may comprise at least one processor; and at least one memory storing instructions that, when executed by the at least one processor, cause the performance of the operations. The method 600 may be carried out by a CTR-WR RX, such as the CTR-WR RX 303 of FIG. 3 or the CTR-WR RX unit 420 of FIG. 4b.

The method 600 of FIG. 6 is similar to the method of FIG. 5, however, is from the perspective of the receiver. As such, the discussion of the method 500 in relation to FIG. 5 applies similarly to the method 600 of FIG. 6.

The method 600 comprises a first operation 601 of receiving, from a transceiver, a sequence of available channels of a plurality of channels in an unlicensed spectrum. A bandwidth of each channel of the sequence of available channels is defined according to a bandwidth configuration defined by a cellular protocol. The selected sequence of available channels comprises a first channel and a second channel.

The first operation 601 may further comprise negotiating with the transceiver to determine the selection of the sequence of available channels from the plurality of channels. The negotiating is based on at least one of the following: a radio frequency capability of at least one of the plurality of channels, a radio frequency capability of a transceiver associated with at least one of the plurality of channels, a resource availability of at least one of the plurality of channels, or a propagation characteristic of at least one of the plurality of channels.

The method 600 comprises a second operation 602 of receiving, from the transceiver, during a first transmission period, a first set of data samples via the first channel.

The method 600 comprises a third operation 603 of receiving, from the transceiver, prior to receiving of the second set of data samples via the second channel, a preamble according to a Wi-Fi protocol. As such synchronization from the preamble of the packets is acquired. Transmission over the air uses the main principles of the Wi-Fi protocol, thus synchronization could be acquired when decoding the Wi-Fi preamble. However, the waveform adopted for the transmission of the data is the one typical from the cellular protocol in use.

The method 600 comprises a fourth operation 604 of receiving, from the transceiver, after expiration of the first transmission period, during a second transmission period, the second set of data samples via the second channel.

The method 600 may optionally comprise transmitting, to the transceiver, at least one quality of service (QoS) requirement. The QoS requirement may be used by the transceiver to determine the selected sequence of available channels. This may result in communication between a CTR-WR TX unit and CTR-WR RX unit to determine the requirements in terms of unlicensed links to establish such to statistically satisfy end-to-end QoS constraints. For example, this could result in the definition of a subset of selected channels that could guarantee a certain probability of maintaining continuous transmissions for a certain required duration.

The method 600 may optionally comprise monitoring the receiving of the first set of data samples and the second set of data samples to determine whether continuous transmission is achieved. As such the receiver and transceiver may communicate to ensure that continuous transmission is achieved and modify the channel selection based on the monitoring. 4.

Keep trace of the successful and unsuccessful events of continuous transmission as a function of activated channels. This contributes to maintain updated per-link statistics that could drive the selection of subsequent channels.

The disclosure herein equally applies to access nodes and terminals (i.e., in place of transceivers and receivers).

The disclosure herein enables smooth cellular protocol coexistence with Wi-Fi in the unlicensed spectrum without the need of protocol modifications.

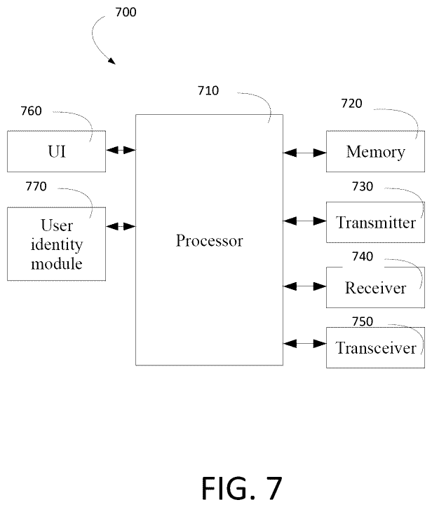

FIG. 7 shows, by way of example, a block diagram of an apparatus capable of performing the method(s) as disclosed herein. Illustrated is device 700, which may comprise, for example, the CTR-WR transmitter or receiver as discussed herein. Comprised in device 700 is processor 710, which may comprise, for example, a single- or multi-core processor wherein a single-core processor comprises one processing core and a multi-core processor comprises more than one processing core. Processor 710 may comprise, in general, a control device. Processor 710 may comprise more than one processor. Processor 710 may be a control device. Processor 710 may comprise at least one application-specific integrated circuit, ASIC. Processor 710 may comprise at least one field-programmable gate array, FPGA. Processor 710 may be means for performing method steps in device 700. Processor 710 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or a network node, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 700 may comprise memory 720. Memory 720 may comprise random-access memory and/or permanent memory. Memory 720 may comprise at least one RAM chip. Memory 720 may comprise solid-state, magnetic, optical and/or holographic memory, for example. Memory 720 may be at least in part accessible to processor 710. Memory 720 may be at least in part comprised in processor 710. Memory 720 may be means for storing information. Memory 720 may comprise instructions, such as computer instructions, that processor 710 is configured to execute. When instructions configured to cause processor 710 to perform certain actions are stored in memory 720, and device 700 overall is configured to run under the direction of processor 710 using the instructions from memory 720, processor 710 and/or its at least one processing core may be considered to be configured to perform said certain actions. Memory 720 may be at least in part external to device 700 but accessible to device 700.

Device 700 may comprise a transmitter 730. Device 700 may comprise a receiver 740. Transmitter 730 and receiver 740 may be configured to transmit and receive, respectively, information in accordance with at least one cellular or non-cellular standard. Transmitter 730 may comprise more than one transmitter. Receiver 740 may comprise more than one receiver. Transmitter 730 and/or receiver 740 may be configured to operate in accordance with global system for mobile communication, GSM, wideband code division multiple access, WCDMA, 5G, long term evolution, LTE, IS-75, wireless local area network, WLAN, e.g. Wi-Fi, Ethernet and/or worldwide interoperability for microwave access, WiMAX, standards, for example.

Device 700 may comprise a near-field communication, NFC, transceiver 750. NFC transceiver 750 may support at least one NFC technology, such as NFC, Bluetooth, Wibree or similar technologies.

Device 700 may comprise user interface, UI, 760. UI 760 may comprise at least one of a display, a keyboard, a touchscreen, a vibrator arranged to signal to a user by causing device 700 to vibrate, a speaker and a microphone. A user may be able to operate device 700 via UI 760, for example to accept incoming telephone calls, to originate telephone calls or video calls, to browse the Internet, to manage digital files stored in memory 720 or on a cloud accessible via transmitter 730 and receiver 740, or via NFC transceiver 750, and/or to play games.

Device 700 may comprise or be arranged to accept a user identity module 770. User identity module 770 may comprise, for example, a subscriber identity module, SIM, card installable in device 700. A user identity module 770 may comprise information identifying a subscription of a user of device 700. A user identity module 770 may comprise cryptographic information usable to verify the identity of a user of device 700 and/or to facilitate encryption of communicated information and billing of the user of device 700 for communication effected via device 700.

Processor 710 may be furnished with a transmitter arranged to output information from processor 710, via electrical leads internal to device 700, to other devices comprised in device 700. Such a transmitter may comprise a serial bus transmitter arranged to, for example, output information via at least one electrical lead to memory 720 for storage therein. Alternatively to a serial bus, the transmitter may comprise a parallel bus transmitter. Likewise processor 710 may comprise a receiver arranged to receive information in processor 710, via electrical leads internal to device 700, from other devices comprised in device 700. Such a receiver may comprise a serial bus receiver arranged to, for example, receive information via at least one electrical lead from receiver 740 for processing in processor 710. Alternatively to a serial bus, the receiver may comprise a parallel bus receiver.

Processor 710, memory 720, transmitter 730, receiver 740, NFC transceiver 750, UI 760 and/or user identity module 770 may be interconnected by electrical leads internal to device 700 in a multitude of different ways. For example, each of the aforementioned devices may be separately connected to a master bus internal to device 700, to allow for the devices to exchange information. However, as the skilled person will appreciate, this is only one example and depending on the embodiment various ways of interconnecting at least two of the aforementioned devices may be selected.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be embodied in the cloud.

The term “means” as used in the description and in the claims may refer to one or more individual elements configured to perform the corresponding recited functionality or functionalities, or it may refer to several elements that perform such functionality or functionalities. Furthermore, several functionalities recited in the claims may be performed by the same individual means or the same combination of means. For example, performing such functionality or functionalities may be caused in an apparatus by a processor that executes instructions stored in a memory of the apparatus.

Implementations of any of the above-described blocks, apparatuses, systems, techniques or methods include, as non-limiting examples, implementations as hardware, software, firmware, special purpose circuits or logic, general purpose hardware or controller or other computing devices, or some combination thereof. Some embodiments may be implemented in the cloud.

It is to be understood that what is described above is what is presently considered the preferred embodiments. However, it should be noted that the description of the preferred embodiments is given by way of example only and that various modifications may be made without departing from the scope as defined by the appended claims.

1-21. (canceled)

22. An apparatus, comprising:
at least one processor; and
at least one memory storing instructions that, when executed by the at least one processor, cause the apparatus at least to perform:
receiving a base band stream;
converting the base band stream into a set of data samples, wherein the set of data samples comprises a first set of data samples and a second set of data samples;
selecting a sequence of available channels from a plurality of channels in an unlicensed spectrum, wherein a bandwidth of each channel of the sequence of available channels is according to a bandwidth configuration defined by a cellular protocol and wherein the selected sequence of available channels comprises a first channel and a second channel;
transmitting, to a receiver, the selected sequence of available channels;
transmitting, to the receiver, during a first transmission period, the first set of data samples via the first channel;
transmitting, to the receiver, prior to transmission of the second set of data samples via the second channel, a preamble according to a Wi-Fi protocol; and
transmitting, to the receiver, after expiration of the first transmission period, during a second transmission period, the second set of data samples via the second channel.

23. The apparatus of claim 22, wherein for transmitting, to a receiver, the selected sequence of available channels, the apparatus is configured to use multi-link operation.

24. The apparatus of claim 22, configured to use at least one channel of the selected sequence of available channels during a preconfigured transmission period, and wherein a first preconfigured transmission period for the first channel is the first transmission period and a second preconfigured transmission period for the second channel is the second transmission period.

25. The apparatus of claim 22, wherein the preamble is according to a Wi-Fi protocol and is configured to enable synchronization between the apparatus and the receiver.

26. The apparatus of claim 22, wherein at least one of the first set of data samples or the second set of data samples are transmitted to the receiver via cellular protocol.

27. The apparatus of claim 22, further configured to:
negotiate with the receiver to determine the selection of the sequence of available channels from the plurality of channels, wherein the negotiating is based on at least one of the following:
a radio frequency capability of at least one of the plurality of channels;
a radio frequency capability of a transceiver associated with at least one of the plurality of channels;
a resource availability of at least one of the plurality of channels; or
a propagation characteristic of at least one of the plurality of channels.

28. The apparatus of claim 22, wherein for selecting the sequence of available channels the apparatus is configured to:
scan at least one channel of the plurality of channels;
acquire an available scanned channel for an occupancy time; and
acquire the available scanned channel for the occupancy time.

29. The apparatus of claim 28, wherein selecting the sequence of available channel further comprises:
upon determining that the occupancy time has expired, acquiring a second available scanned channel for a second occupancy time.

30. The apparatus of claim 22, further configured to:
receive, from the receiver, at least one quality of service (QoS) requirement, and
select a sequence of available channels from the plurality of channels, based on the QoS requirement.

31. The apparatus of claim 22, wherein the apparatus comprises a continuous transmission and reception wrapper transmission unit -CTR-WR TX-, the CTR-WR TX configured to provide continuous transmission to the receiver, using a plurality of unlicensed channels and the preamble according to a Wi-Fi protocol.

32. An apparatus, comprising:
at least one processor; and
at least one memory storing instructions that, when executed by the at least one processor, cause the apparatus at least to:
receive, from a transceiver, a sequence of available channels of a plurality of channels in an unlicensed spectrum, wherein a bandwidth of each channel of the sequence of available channels is according to a bandwidth configuration defined by a cellular protocol and wherein the selected sequence of available channels comprises a first channel and a second channel;
receive, from the transceiver, during a first transmission period, a first set of data samples via the first channel;
receive, from the transceiver, prior to receiving of the second set of data samples via the second channel, a preamble according to a Wi-Fi protocol; and
receive, from the transceiver, after expiration of the first transmission period, during a second transmission period, the second set of data samples via the second channel.

33. The apparatus of claim 32, wherein for receiving, from the transceiver, the selected sequence of available channels the apparatus is configured to use multi-link operation.

34. The apparatus of claim 32, configured to use at least one channel of the selected sequence of available channels during a preconfigured transmission period, wherein a first preconfigured transmission period for the first channel is the first transmission period and a second preconfigured transmission period for the second channel is the second transmission period.

35. The apparatus of claim 32, wherein the preamble is according to a Wi-Fi protocol and is configured to enable synchronization between the apparatus and the transceiver.

36. The apparatus of claim 32, wherein at least one of the first set of data samples or the second set of data samples are received from the transceiver via cellular protocol.

37. The apparatus of claim 32, further configured to:
Negotiate with the transceiver to determine the selection of the sequence of available channels from the plurality of channels, wherein the negotiating is based on at least one of the following:
a radio frequency capability of at least one of the plurality of channels;
a radio frequency capability of a transceiver associated with at least one of the plurality of channels;
a resource availability of at least one of the plurality of channels; or
a propagation characteristic of at least one of the plurality of channels.

38. The apparatus of claim 32, further configured to:
transmit, to the transceiver, at least one quality of service (QoS) requirement.

39. The apparatus of claim 32, further configured to:
monitor the receiving of the first set of data samples and the second set of data samples to determine whether continuous transmission is achieved.

40. The apparatus of claim 32, wherein the apparatus comprises a continuous transmission and reception wrapper receiver unit -CTR-WR RX-, the CTR-WR RX configured to receive continuous transmission from the transceiver using a plurality of unlicensed channels and the preamble according to a Wi-Fi protocol.

41. A method, comprising:
receiving a base band stream;
converting the base band stream into a set of data samples, wherein the set of data samples comprises a first set of data samples and a second set of data samples;
selecting a sequence of available channels from a plurality of channels in an unlicensed spectrum, wherein a bandwidth of each channel of the sequence of available channels is according to a bandwidth configuration defined by a cellular protocol and wherein the selected sequence of available channels comprises a first channel and a second channel;
transmitting, to a receiver, the selected sequence of available channels;
transmitting, to the receiver, during a first transmission period, the first set of data samples via the first channel;
transmitting, to the receiver, prior to transmission of the second set of data samples via the second channel, a preamble according to a Wi-Fi protocol; and
transmitting, to the receiver, after expiration of the first transmission period, during a second transmission period, the second set of data samples via the second channel.
